(19) United States
(12) Patent Application Publication
(10) Pub. No.: US 2021/0382684 A1
(43) Pub. Date: Dec. 9, 2021

(54) INFORMATION DISPLAY APPARATUS, ELECTRONIC DEVICE, ELECTRONIC PEN, SYSTEM, METHOD AND PROGRAM

(71) Applicant: KYOCERA Corporation, Kyoto (JP)

(72) Inventors: Hidetoshi HACHIYA, Yokohama-shi, Kanagawa (JP); Takayuki YAJIMA, Miura-gun, Hayama-machi, Kanagawa (JP); Tadashi SHINTANI, Yokohama-shi, Kanagawa (JP); Jun WADA, Kawasaki-shi, Kanagawa (JP); Katsuaki OONISHI, Yokohama-shi, Kanagawa (JP)

(73) Assignee: KYOCERA Corporation, Kyoto (JP)

(21) Appl. No.: 17/288,297

(22) PCT Filed: Sep. 30, 2019
(86) PCT No.: PCT/JP2019/038499

§ 371 Date: Apr. 23, 2021

(30) Foreign Application Priority Data
Oct. 29, 2018 (JP) 2018-203311
Oct. 29, 2018 (JP) 2018-203313
Oct. 29, 2018 (JP) 2018-203315
Oct. 29, 2018 (JP) 2018-203316
Oct. 29, 2018 (JP) 2018-203317

(51) Int. Cl. G06F 3/16; G06F 3/0488

(52) U.S. Cl. CPC G06F 3/167; G06F 3/04883

(57) ABSTRACT

A display control method for use in an information display apparatus including a touch panel configured to accept handwriting input with an indication body, the method includes: accepting audio input including an audio command in a handwriting input state; displaying a trajectory of handwriting accepted by the touch panel; controlling a display mode of the trajectory of handwriting in displaying the trajectory, according to the audio command input and accepted in accepting the audio input.

### TECHNICAL FIELD

The present invention relates to an information display apparatus, electronic device, electronic pen, system, method, and program.

### BACKGROUND ART

Information display apparatuses having a touch panel for accepting handwriting input have become widely used. Such an information display apparatus accepts handwriting input with an indication body such as a pen or a finger by its touch panel and displays the trajectory of the handwriting that represents a character or a graphic (see Patent Literature 1, for example).

When an electronic pen is used as the indication body, the information display apparatus accepts handwriting input with the electronic pen by the touch panel and displays the trajectory of the handwriting that represents a character or a graphic after the launch of a pen input application.

In recent years, techniques to perform speech recognition and translation to other languages and output the result of the translation by an electronic device such as a smartphone have been put to practical use.

In those techniques, an electronic device having a microphone and a speaker picks up a voice spoken in a first language by the microphone, converts (translates) the obtained sound data to data in a second language that is different from the first language, and outputs the resulting data by the speaker (see Patent Literature 2, for example).

### CITATION LIST

### Patent Literature

Patent Literature 1: Japanese Patent Application Laid-Open No. 2017-152018

Patent Literature 2: Japanese Patent Application Laid-Open No. 2018-60165

### SUMMARY OF INVENTION

An information display apparatus according to a first feature includes: a touch panel configured to accept handwriting input with an indication body; a displayer configured to display a trajectory of handwriting accepted by the touch panel; an audio inputter configured to accept audio input including an audio command; and a controller configured to control a display mode of the trajectory of handwriting on the displayer according to the audio command input to and accepted by the audio inputter in a handwriting input state.

An electronic pen according to a second feature functioning as the indication body.

A display control method according to a third feature is a method for use in an information display apparatus including a touch panel configured to accept handwriting input with an indication body. The display control method includes: accepting audio input including an audio command in a handwriting input state; displaying a trajectory of handwriting accepted by the touch panel; in displaying the trajectory, controlling a display mode of the trajectory of handwriting according to the audio command and accepted in accepting the audio input.

A program according to a fourth feature is for causing an information display apparatus including a touch panel configured to accept handwriting input with an indication body to: accept audio input including an audio command in a handwriting input state; display a trajectory of handwriting accepted by the touch panel, and in displaying the trajectory; and control a display mode of the trajectory of handwriting according to the audio command and accepted in accepting the audio input.

A pen input system according to a fifth feature includes: an electronic pen; and an information display apparatus including a touch panel configured to accept handwriting input with the electronic pen. The electronic pen includes a first sensor configured to detect acceleration or pen pressure, and a transmitter configured to transmit data depending on a result of detection by the first sensor to the information display apparatus. The information display apparatus includes a receiver configured to receive the data from the electronic pen, and a processor configured to launch an application for providing the handwriting input with the electronic pen based on the data received by the receiver.

An information display apparatus according to a sixth feature includes: a touch panel configured to accept handwriting input with an electronic pen; a receiver configured to receive, from the electronic pen, data depending on a result of detecting acceleration exerted on the electronic pen or pen pressure; and a processor configured to launch an application for providing the handwriting input with the electronic pen based on the data received by the receiver.

An electronic pen according to a seventh feature is used in handwriting input on a touch panel of an information display apparatus. The electronic pen includes a sensor configured to detect acceleration exerted on the electronic pen or pen pressure; and a transmitter configured to transmit data depending on a result of detection by the sensor to the information display apparatus. The data is used to direct the information display apparatus to launch an application for providing the handwriting input.

A control method according to an eighth feature is a control method for an information display apparatus including a touch panel configured to accept handwriting input with an electronic pen. The control method includes: receiving, from the electronic pen, data depending on a result of detecting acceleration exerted on the electronic pen or pen pressure; and launching an application for providing the handwriting input with the electronic pen based on the data received in the receiving.

A program according to a nine feature is for causing an information display apparatus including a touch panel configured to accept handwriting input with an electronic pen to receive, from the electronic pen, data depending on a result of detecting acceleration exerted on the electronic pen or pen pressure; and launch an application for providing the handwriting input with the electronic pen based on the data received in the receiving.

An electronic device according to a ten feature is an electronic device for controlling an external device capable of inputting and outputting audio. The electronic device includes: an audio inputter; an audio outputter; a communication interface configured to establish a radio connection to the external device; and a processor configured to communicate with the external device via the communication interface. The processor being configured to perform a first process of converting audio data in a first language obtained by the audio inputter to audio data in a second language and transmitting the audio data in the second language to the external device via the communication interface, and a second process of receiving audio data in the second language obtained by the external device from the external device via the communication interface, converting the audio data in the second language to audio data in the first language, and outputting audio corresponding to the audio data in the first language by the audio outputter.

An electronic pen according to an eleventh feature functioning as the external device.

A method according to a twelfth feature is the method for use in an electronic device including an audio inputter and an audio outputter. The method includes: establishing a radio connection to an external device capable of inputting and outputting audio; controlling the external device via the radio connection; converting audio data in a first language obtained by the audio inputter to audio data in a second language and transmitting the audio data in the second language to the external device via the radio connection; receiving audio data in the second language obtained by the external device from the external device via the radio connection; and converting the received audio data in the second language to audio data in the first language and outputting audio corresponding to the audio data in the first language by the audio outputter.

A program according to thirteenth feature is for causing an electronic device including an audio inputter and an audio outputter to establish a radio connection to an external device capable of inputting and outputting audio; control the external device via the radio connection; convert audio data in a first language obtained by the audio inputter to audio data in a second language and transmit the audio data in the second language to the external device via the radio connection; receive audio data in the second language obtained by the external device from the external device via the radio connection; and convert the received audio data in the second language to audio data in the first language and output audio corresponding to the audio data in the first language by the audio outputter.

### BRIEF DESCRIPTION OF DRAWINGS

FIG. 1 is a diagram illustrating the exterior of an information display apparatus according to a first embodiment.

FIG. 2 is a block diagram illustrating the functional configuration of the information display apparatus according to the first embodiment.

FIG. 3 is a diagram illustrating the exterior of an electronic pen according to the first embodiment.

FIG. 4 is a block diagram illustrating the functional configuration of the electronic pen according to the first embodiment.

FIG. 5 is a diagram illustrating an exemplary handwriting input screen according to the first embodiment.

FIG. 6 is a diagram illustrating an example of changing the display mode of the trajectory of handwriting in stages according to the first embodiment.

FIG. 7 is a diagram illustrating an example of changing the display mode of the trajectory of handwriting according to the first embodiment.

FIG. 8 is a diagram illustrating another example of changing the display mode of the trajectory of handwriting according to the first embodiment.

FIG. 9 is a diagram illustrating a handwriting input state according to the first embodiment.

FIG. 10 is a diagram illustrating an exemplary operational flow of the information display apparatus and an electronic pen according to the first embodiment.

FIG. 11 is a diagram illustrating another exemplary operational flow of the information display apparatus and the electronic pen according to the first embodiment.

FIG. 12 is a diagram illustrating an operational flow of a pen input system according to a second embodiment.

FIG. 13 is a diagram illustrating an exemplary a launch motion according to the second embodiment.

FIG. 14 is a diagram illustrating an exemplary a launch motion according to the second embodiment.

FIG. 15 is a diagram illustrating an exemplary a launch motion according to the second embodiment.

FIG. 16 is a diagram illustrating the exterior of an electronic device according to a third embodiment.

FIG. 17 is a block diagram illustrating the functional configuration of the electronic device according to the third embodiment.

FIG. 18 is a block diagram illustrating the functional configuration of the electronic pen according to the third embodiment.

FIG. 19 is a diagram illustrating an operational flow of the electronic device and the electronic pen according to the third embodiment.

### DESCRIPTION OF EMBODIMENTS

The following describes an embodiment with reference to drawings. In the following description of the drawings, parts identical or similar to each other are denoted by reference signs identical or similar to each other.

### First Embodiment

In a conventional information display apparatus, when the display mode of a handwriting trajectory is changed, a user has to perform an input operation to change the display mode of the handwriting trajectory with an indication body before or after handwriting input. This operation is cumbersome.

Moreover, if the information display apparatus displays a GUI (e.g., a window, icon, and button) for accepting an input operation to change the display mode, the GUI occupies some part of the limited display area of the information display apparatus, which may further deteriorate the operability of handwriting input.

In view of the above, a first embodiment achieves improvement in the operability when the display mode of a handwriting trajectory is changed.

### (Configuration of Information Display Apparatus)

An information display apparatus according to the first embodiment may be a terminal such as a smartphone and a tablet. The information display apparatus is, however, not limited to such a terminal and may be, for example, a personal computer, an electronic blackboard, or an onboard information display apparatus.

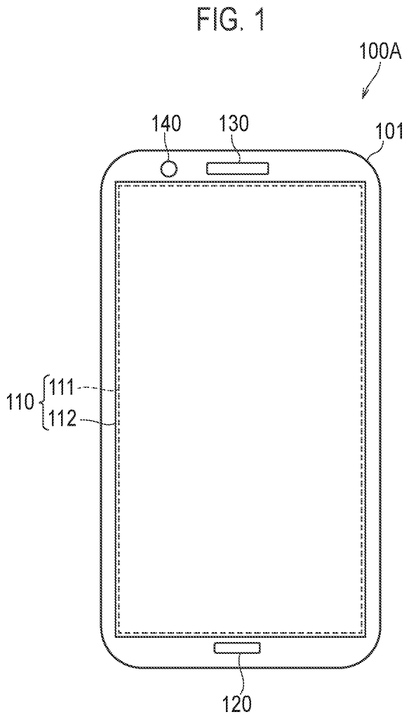

FIG. 1 is a diagram illustrating the exterior of an information display apparatus 100A according to a first embodiment.

As illustrated in FIG. 1, an information display apparatus 100A includes touchscreen display 110, a microphone 120, a speaker 130 and a camera 140.

The touchscreen display 110 is provided with its display surface exposed outside the housing 101 of the information display apparatus 100A. The touchscreen display 110 includes a touch panel 111 and a displayer (display) 112.

The touch panel 111 accepts operational input (touch input) to the information display apparatus 100A. The touch panel 111 detects a touch with an indication body such as user's finger or an electronic pen. For example, resistive touch detection or capacitive touch detection may be executed for detecting a touch but any other kind of touch detection may also be used. The touch panel 111 detects a touch input by a user and outputs data on coordinates (touch coordinates) indicated by the touch input to a controller 180.

The displayer 112 generates visual output. The displayer 112 display objects such as characters (including symbols), images and graphics on the screen. For example, a liquid crystal display or an organic electro luminescence (EL) display may be used for the displayer 112.

In the touchscreen display 110 according to the first embodiment, the displayer 112 is provided so that the displayer 112 can overlap the touch panel 111 and thus the display area of the displayer 112 can also overlap the touch panel 111. The displayer 112 and the touch panel 111 may, however, be placed side by side or even spaced instead of providing the displayer 112 and the touch panel 111 so that they can overlap.

The microphone 120 accepts audio input to the information display apparatus 100A. The microphone 120 picks up surrounding sounds.

The speaker 130 generates audio output. The speaker 130 outputs audio on the telephone or information for a variety of programs as audio output.

The camera 140 captures images electronically using an image sensor such as a charge coupled device (CCDs) or a complementary metal oxide semiconductor (CMOS). The camera 140 is a front camera that captures images of objects located in front of the touchscreen display 110. The information display apparatus 100A may further includes a rear camera to capture images of objects located on the back side of the touchscreen display 110.

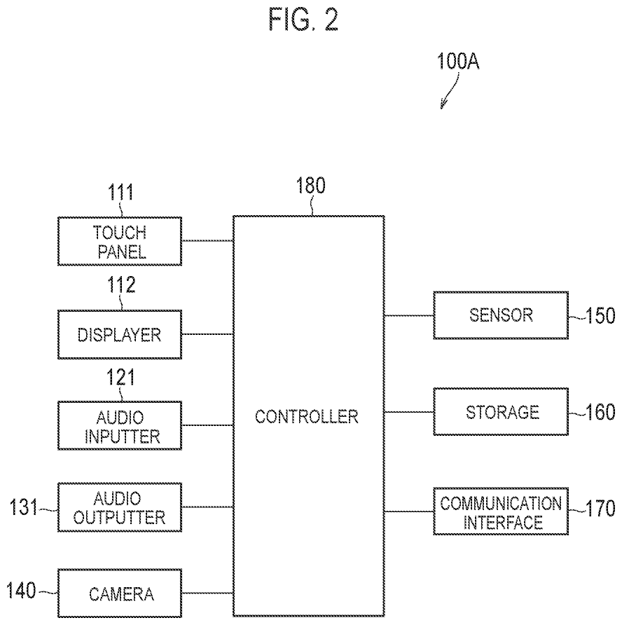

FIG. 2 is a block diagram illustrating the functional configuration of the information display apparatus 100A according to the first embodiment.

As illustrated in FIG. 2, the information display apparatus 100A includes the touch panel 111, the displayer 112, an audio inputter 121, an audio outputter 131, the camera 140, a sensor 150, a storage 160, a communication interface 170 and the controller 180.

The touch panel 111 inputs a signal corresponding to a detected touch operation with the indication body to the controller 180. The touch panel 111 accepts handwriting input with an electronic pen during execution of a handwriting input application that is described below.

The displayer 112 displays objects such as characters, images and graphics based on a signal input by the controller 180. The displayer 112 also displays the trajectory of handwriting (e.g., a character or a graphic) input to and accepted by the touch panel 111 during execution of the handwriting input application.

The audio inputter 121 inputs a signal corresponding to an accepted audio input to the controller 180. The audio inputter 121 includes the aforementioned microphone 120. The audio inputter 121 may be an input interface to which an external microphone can be connected. The external microphone may be connected in a wired or wireless manner. The microphone connected to the input interface may be a microphone integrated with earphones that can be connected to the information display apparatus 100A. In the first embodiment, the external microphone is provided in an electronic pen.

The audio outputter 131 outputs audio based on a signal input by the controller 180. The audio outputter 131 includes the aforementioned speaker 130. The audio outputter 131 may be an output interface to which an external speaker can be connected. The external speaker may be connected in a wired or wireless manner. The speaker connected to the output interface may be a speaker included in earphones that can be connected to the information display apparatus.

The camera 140 converts a captured image into an electronic signal and inputs the electronic signal to the controller 180.

The sensor 150 detects acceleration or vibration exerted on the information display apparatus 100A and outputs a detection signal corresponding to the result of detection to the controller 180. The sensor 150 includes an acceleration sensor. The acceleration sensor detects the direction and magnitude of acceleration exerted on the information display apparatus 100A.

The storage 160 stores programs and data. The storage 160 is also used as a workspace for temporarily storing results of processing by the controller 180. The storage 160 may include any non-transitory storage medium such as a semiconductor storage medium and a magnetic storage medium.

The storage 160 may include multiple types of storage media. The storage 160 may include a combination of a portable storage medium such as a memory card, an optical disc and a magneto-optical disc and a reader for the storage medium. The storage 160 may include a memory device, for example, a random access memory (RAM), which can be used as a temporary storage area.

Programs stored in the storage 160 includes applications that can be executed in the foreground or background and a control program that supports operations of those applications.

Programs stored in the storage 160 includes the handwriting input application. The handwriting input application is an application that accepts handwriting input with an electronic pen by the touch panel 111 and displays the trajectory of the handwriting (e.g., a character or a graphic) by the displayer 112.

In the first embodiment, the handwriting input application has a function of performing a speech recognition process on audio data obtained by the audio inputter 121. The speech recognition process is a process of recognizing an audio command included in the audio data. Audio commands and corresponding operations are registered with the storage 160 in advance.

The communication interface 170 can communicate wirelessly. The communication interface 170 may support radio communication standards including cellular communication standards such as 2G, 3G and 4G and short-range radio communication standards. Examples of the short-range radio communication standards include IEEE 802.11, Bluetooth (R), Infrared Data Association (IrDA), Near Field Communication (NFC) and Wireless Personal Area Network (WPAN). ZigBee (R) is an example of the WPAN communication standard.

The controller 180 is an arithmetic processing device. The arithmetic processing device includes for example, but is not limited to, a central processing unit (CPU), a system-on-chip (SoC), a micro control unit (MCU), a field-programmable gate array (FPGA) and a coprocessor. The controller 180 includes a graphics processing unit (GPU) and a video RAM (VRAM) and renders various kinds of images on the displayer 112. The controller 180 realizes a wide variety of functions by orchestrating the operation of the information display apparatus 100A.

The controller 180 detects whether the information display apparatus 100A is connected with an external device. The connections may be established in a wired or wireless manner. An example of communication standards for radio connection is Bluetooth (R). The controller 180 communicates with the external device via the communication interface 170. The connected external device may be the aforementioned earphones, a headset, an onboard speaker with a microphone or an electronic pen. It is noted that the communication standards for radio connection and the external device are not limited to those described above. In the following, an electronic pen is connected as an external device by way of example.

The controller 180 performs various kinds of control based on a signal input depending on a touch operation detected by the touch panel 111. For example, the controller 180 controls the audio outputter 131 or the displayer 112 to generate output according to an input signal. The controller 180 also executes functions and changes settings of the information display apparatus 100A.

The controller 180 obtains touch coordinate data corresponding to a touch position from the touch panel 111 when a user gives a handwriting input (touch input) using the touch panel 111 during execution of the handwriting input application.

A user performs operations on the touch panel 111 with an electronic pen or his/her finger. The types of inputs provided using the touch panel 111 include a tap (short press), a slide (drag), a flick and a long touch (long press). These inputs may be referred to as “touch inputs” or simply “inputs.”

A transition from a state in which the touch panel 111 is not touched to another state in which the touch panel 111 is touched is called a touch-on (pen-down) and a transition from a state in which the touch panel 111 is touched to another state in which the touch panel 111 is not touched is called a touch-off (pen-up). The touch panel 111 may output touch coordinate data corresponding to the current touch position at short intervals for continuous touch input such as slide input and flick input.

The touch panel 111 outputs to the controller 180 touch coordinate data corresponding to a series of touch positions from a touch-on (pen-down) to a touch-off (pen-up). The controller 180 directs the displayer 112 to display the trajectory of handwriting represented by the series of touch coordinate data.

### (Configuration of Electronic Pen)

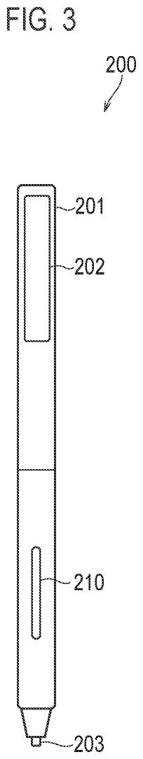

FIG. 3 is a diagram illustrating the exterior of the electronic pen 200 according to the first embodiment.

As illustrated in FIG. 3, an electronic pen 200 includes a housing 201, a clip portion 202, a core body 203 and an operator 210.

The housing 201 has a cylindrical shape. The clip portion 202 is provided on the upper side of the electronic pen 200 (housing 201). The core body 203 and the operator 210 are provided on the lower side of the electronic pen 200 (housing 201). The operator 210 is a button that can be pressed down with a finger.

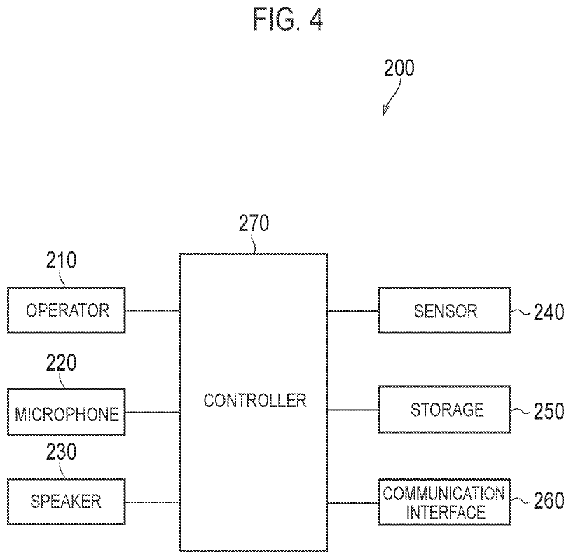

FIG. 4 is a block diagram illustrating the functional configuration of the electronic pen 200 according to the first embodiment.

As illustrated in FIG. 4, the electronic pen 200 includes the operator 210, a microphone 220, a speaker 230, a sensor 240, a storage 250, a communication interface 260 and a controller 270.

The operator 210 inputs a signal corresponding to a detected press-down operation to the controller 270.

The microphone 220 picks up surrounding sounds. The microphone 220 accepts an audio input to the electronic pen 200 and inputs a signal corresponding to the accepted audio input to the controller 270.

The speaker 230 generates audio output. The speaker 230 outputs audio on the telephone or information for a variety of programs as audio output. The speaker 230 outputs audio based on a signal input by the controller 270.

The sensor 240 detects acceleration exerted on the electronic pen 200 or pen pressure and outputs a detection signal corresponding to the result of detection to the controller 270. The sensor 240 includes an acceleration sensor. The acceleration sensor detects the direction and magnitude of acceleration exerted on the electronic pen 200. The sensor 240 may further include a gyro sensor that detects the angles and angular velocities of the information display apparatus 100A.

The sensor 240 further includes a pen-pressure sensor. The pen pressure sensor detects pressure exerted on the core body 203 (i.e., the tip of the electronic pen 200) and outputs a signal corresponding to the result of detection to the controller 270.

The storage 250 stores programs and data. The storage 250 is also used as a workspace for temporarily storing results of processing by the controller 270. The storage 250 may include any non-transitory storage medium such as a semiconductor storage medium and a magnetic storage medium.

The storage 250 may include multiple types of storage media. The storage 250 may include a combination of a portable storage medium such as a memory card and a reader for the storage medium. The storage 250 may include a memory device, for example, a RAM, which can be used as a temporary storage area.

The communication interface 260 can communicate wirelessly. The communication interface 260 may support radio communication standards including the aforementioned cellular communication standards and short-range radio communication standards.

The controller 270 is an arithmetic processing device. The arithmetic processing device includes, but is not limited to, a CPU, an SoC, an MCU, an FPGA and a coprocessor. The controller 270 realizes a wide variety of functions by orchestrating the operation of the electronic pen 200.

The controller 270 detects whether the electronic pen 200 is connected with the information display apparatus 100A. The connection may be established in a wired or wireless manner. An example of communication standards for radio connection is Bluetooth (R). The controller 270 communicates with the information display apparatus 100A via the communication interface 260.

The controller 270 performs various kinds of control based on a signal input depending on a press-down operation detected by the operator 210. The controller 270 transmits data depending on the result of detection by the sensor 240 if the electronic pen 200 is connected with the information display apparatus 100A.

In the first embodiment, the controller 270 has a function of performing a speech recognition process. The speech recognition process is a process of recognizing an audio command included in audio data. Audio commands and corresponding operations may be registered with the storage 250 in advance.

### (Handwriting Input Operation)

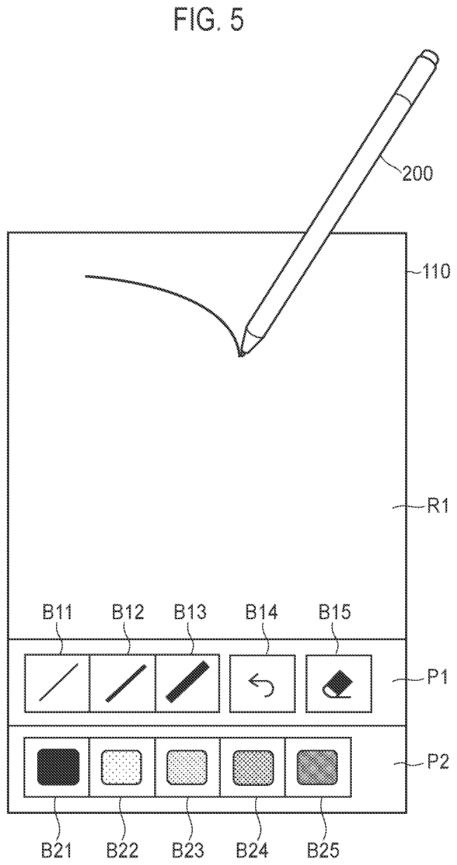

FIG. 5 is a diagram illustrating an exemplary handwriting input screen. The controller 180 of the information display apparatus 100A directs the touchscreen display 110 (displayer 112) to display a handwriting input screen as illustrated in FIG. 5 during execution of the handwriting input application.

As illustrated in FIG. 5, the handwriting input screen includes a handwriting input area R1, a tool pallet area P1 and a color pallet area P2.

The handwriting input area R1 is an area in which the trajectory of handwriting is displayed. FIG. 5 illustrates an example of handwriting input by a user using the electronic pen 200. In general, the user inputs a character in the handwriting input area R1 with the electronic pen 200 to take a note, for example. The character includes a number and a symbol. Alternatively, the user inputs a graphic in the handwriting input area R1 with the electronic pen 200 to draw an illustration, for example. The graphic includes a curve, a straight line, a circle and a polygon.

The tool pallet area P1 is an area to display buttons B11 to B13 to change the thickness (line width) of the trajectory of handwriting, a button B14 to cancel (undo) the previous handwriting input and an eraser button B15 to designate a portion to be deleted with the indication body. The color pallet area P2 is an area to display color buttons B21 to B25 corresponding to respective colors such as black, red, blue, green and yellow.

The user may select the line color and the line width of the trajectory of handwriting (a character or a graphic) or fill a plane (enclosed by a closed curve) that constitutes a portion of a drawn graphic with a desirable color using the buttons in the tool pallet area P1 and the color pallet area P2. Thus, every time the display mode (attribute) of the trajectory of handwriting is changed, operations are needed to select and change the display mode using, for example, the tool pallet area P1 and the color pallet area P2.

According to the first embodiment, the display mode can be changed by voice. In particular, in the information display apparatus 100A according to the first embodiment, the audio inputter 121 accepts audio input including an audio command

The audio inputter 121 may accept audio input by obtaining from electronic pen 200 audio data including an audio command based on audio input to the microphone 220 of the electronic pen 200. The microphone 220 of the electronic pen 200 can pick up sounds at a position nearer to the user. Even if the information display apparatus 100A does not have a suitable microphone, the microphone 220 of the electronic pen 200 enables audio input.

When the microphone 220 of the electronic pen 200 is used, the speech recognition process to recognize the audio command may be performed by the controller 180 of the information display apparatus 100A or the controller 270 of the electronic pen 200.

Alternatively, the audio inputter 121 may accept audio input by obtaining audio data including an audio command based on audio input to the microphone 120 of the information display apparatus 100A. That is, audio input is conducted without using the microphone 220 of the electronic pen 200. In this case, the speech recognition process to recognize the audio command is performed by the controller 180 of the information display apparatus 100A.

Audio commands may be defined corresponding to the buttons in the tool pallet area P1 and the color pallet area P2.

For example, audio commands may directly correspond to the buttons, e.g., the audio command corresponding to the button B11 may be “change the line width to the thinnest width” and the audio command corresponding to the button B13 may be “change the line width to the thickest width.” Alternatively, a relative audio command “increase the line thickness” may be used to change the line width from the line width corresponding to the button B11 to the line width corresponding to the button B12, from the line width corresponding to the button B12 to the line width corresponding to the button B13, or from the line width corresponding to the button B13 to a certain thicker line width. That is, the controller 180 of the information display apparatus 100A may change the currently selected display mode to another display mode that is of the same type as the currently selected display mode and different from the currently selected display mode based on a relative audio command

The audio command corresponding to the button B14 may be “undo.” The audio command corresponding to the button B15 may be “eraser.”

The audio commands corresponding to the buttons B21 to B25 specify corresponding pen colors respectively. For example, the audio commands may be “switch to the blue pen” or “switch to the red pen.” Alternatively, an audio command “change the pen color to red gradually” may be used to produce a gradation from the currently selected color to red. Alternatively, an audio command “change the pen color from blue to red gradually” may be used to produce a gradation from blue to red. That is, the controller 180 of the information display apparatus 100A may change the display mode in stages from the currently selected or specified display mode to another display mode that is of the same type as the currently selected or specified display mode based on an audio command including specification of one or more display modes of the same type and other predetermined audio commands (e.g., “gradually” in the above example).

The controller 180 controls the display mode of the trajectory of handwriting on the displayer 112 according to an audio command input to and accepted by the audio inputter 121 in a handwriting input state. The display mode includes at least one of the color, size, thickness, font and decoration of a character and the color, size, line width and shape of a graphic.

In this way, the user can change the display mode of the trajectory of handwriting by voice without performing input operations for the change with the indication body, which can improve the operability.

In addition, since the display mode can be changed by voice, it is possible to omit the tool pallet area P1 and the color pallet area P2 illustrated in FIG. 5 and expand the handwriting input area R1 accordingly.

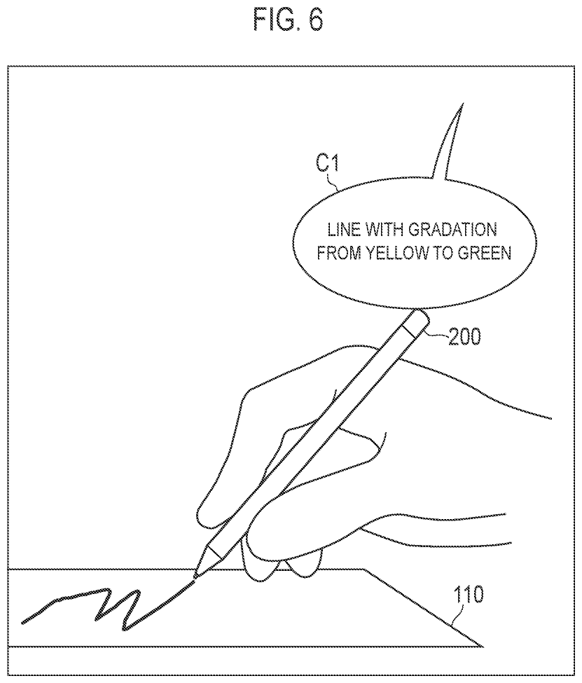

It is also possible to perform advanced operations by voice which are not implemented in the tool pallet area P1 and the color pallet area P2 illustrated in FIG. 5. Examples of such advanced operations are illustrated in FIGS. 6 to 8.

FIG. 6 is a diagram illustrating an example of changing the display mode of the trajectory of handwriting in stages. As illustrated in FIG. 6, in the handwriting input state (more specifically, a touched state), when the audio inputter 121 accepts an input including an audio command C1 “line with a gradation from yellow to green,” the controller 180 recognizes the audio command C1 and changes the line color of the trajectory of handwriting from yellow to green in stages.

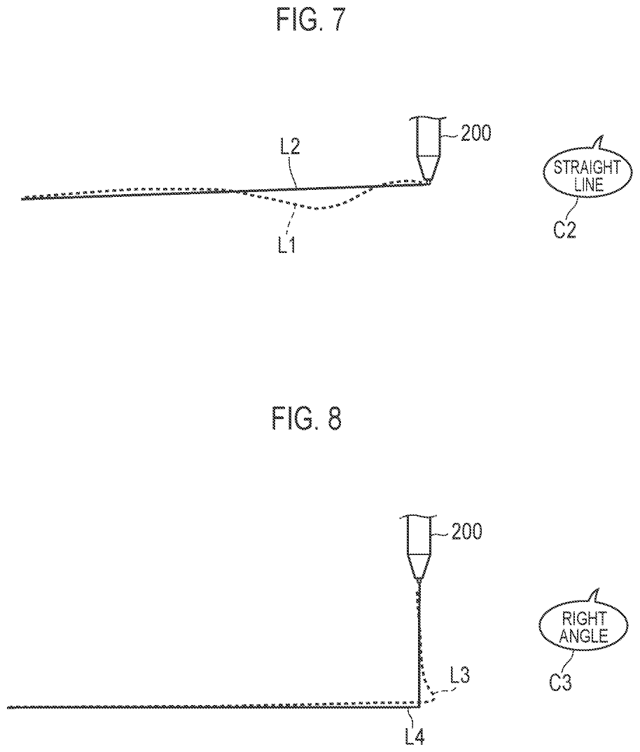

FIG. 7 is a diagram illustrating an example of changing the display mode of the trajectory of handwriting. As illustrated in FIG. 7, the trajectory L1 of handwriting is drawn. In the handwriting input state, when the audio inputter 121 accepts an input including an audio command C2 “straight line,” the controller 180 recognizes the audio command C2 and transforms the trajectory L1 of handwriting into a straight line L2.

FIG. 8 is a diagram illustrating another example of changing the display mode of the trajectory of handwriting. As illustrated in FIG. 8, the trajectory of handwriting L3 is drawn. In the handwriting input state, when the audio inputter 121 accepts an input including an audio command C3 “right angle,” the controller 180 recognizes the audio command C3 and transforms the trajectory L3 of handwriting into a line L4 that bends at a right angle.

### (Handwriting Input State)

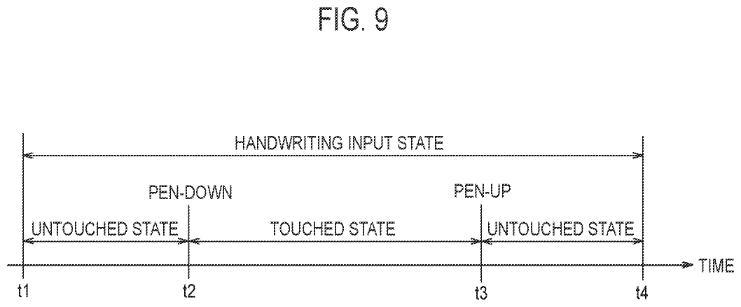

FIG. 9 is a diagram illustrating a handwriting input state according to the first embodiment.

As illustrated in FIG. 9, the handwriting input state includes a touched state in which the electronic pen 200 is in contact with the display surface of the touchscreen display 110 (displayer 112).

The controller 180 controls the display mode of the trajectory of handwriting on the displayer 112 according to an audio command input to and accepted by the audio inputter 121 in the touched state. Thus, the display mode of the trajectory of handwriting can be changed by voice during handwriting input.

For example, in the touched state, when the audio inputter 121 accepts an input including an audio command “switch to the red pen,” the controller 180 recognizes the audio command and changes the color of the trajectory of handwriting in the middle of the trajectory.

In the touched state, when the audio inputter 121 accepts an input including an audio command “change the line width to the thickest width,” the controller 180 recognizes the audio command and changes the line width of the trajectory of handwriting to the thickest width in the middle of the trajectory.

In the touched state, when the audio inputter 121 accepts an input including an audio command “increase the line width,” the controller 180 recognizes the audio command and increases the line width of the trajectory of handwriting by one level in the middle of the trajectory. After that, before pen-up, if the audio inputter 121 accepts another input including the audio command “increase the line width,” the controller 180 recognizes the audio command and increases the line width of the trajectory of handwriting by one level again in the middle of the trajectory. In this way, the controller 180 changes the trajectory of handwriting in stages when the controller 180 accepts the same audio command repeatedly.

After that, before pen-up, if the audio inputter 121 accepts another input including an audio command “decrease the line width,” the controller 180 recognizes the audio command and decreases the line width of the trajectory of handwriting by one level in the middle of the trajectory.

This enables stepwise change of the line width of the trajectory of handwriting during handwriting input. In such stepwise change, the line width may not be changed acutely but may be changed smoothly.

Alternatively, in the touched state, when the line color is blue and the audio inputter 121 accepts an input including an audio command “change the line color to a redder color,” the controller 180 recognizes the audio command and changes the line color of the trajectory of handwriting to a color one level redder than the current line color (e.g., bluish purple) in the middle of the trajectory.

After that, before pen-up, if the audio inputter 121 accepts another input including the audio command “change the line color to a redder color,” the controller 180 recognizes the audio command and changes the line color of the trajectory of handwriting to a one-level redder color (e.g., purple) again in the middle of the trajectory.

After that, before pen-up, if the audio inputter 121 accepts yet another input including the audio command “change the line color to a redder color,” the controller 180 recognizes the audio command and changes the line color of the trajectory of handwriting to a one-level redder color (e.g., reddish purple) again in the middle of the trajectory.

This enables stepwise change of the line color of the trajectory of handwriting during handwriting input. In such stepwise change, the line color may not be changed acutely but may be changed smoothly by rendering the line with a gradation from blue to red.

Alternatively, during character input, in the touched state, when the audio inputter 121 accepts an input including an audio command “this part is important,” the controller 180 recognizes the audio command and may change the color of a part of the trajectory of handwriting within a predetermined time period or a predetermined length before and after recognizing the audio command to red or highlight (adds a marker to) that part. This type of audio command changes (more specifically, highlights) the display mode in a predetermined range before and after recognizing the audio commands in a uniform manner during the handwriting.

Alternatively, during character input, in the touched state, when the audio inputter 121 accepts an input including an audio command “the part up to here is important,” the controller 180 recognizes the audio command and may change the color of a part of the trajectory of handwriting from the time t2 of pen-down to the time of recognizing the audio command to red or highlight that part. This type of audio command changes (more specifically, highlights) the display mode of the trajectory of handwriting in a predetermined range immediately before recognizing the audio commands in a uniform manner during the handwriting.

Alternatively, during character input, in the touched state, when the audio inputter 121 accepts an input including an audio command “the part from here is important,” the controller 180 recognizes the audio command and may change the color of a part of the trajectory of handwriting from the time of recognizing the audio command to the time t3 of pen-up to red or highlight that part. This type of audio command changes (more specifically, highlights) the display mode of the trajectory of handwriting in a predetermined range immediately after recognizing the audio commands in a uniform manner during the handwriting.

After the audio command “the part from here is important” is input, if the audio command “the part up to here is important” is input before pen-up, the color of a part of the trajectory of handwriting from the time of recognizing the audio command “the part from here is important” to the time of recognizing the audio command “the part up to here is important” may be changed to red or that part may be highlighted.

The handwriting input state may include an untouched state immediately after the touched state. In particular, the handwriting input state may include an untouched state in a predetermined time period after the time t3 of removal of the electronic pen 200 from the display surface of the touchscreen display 110 (displayer 112) (i.e., the time of pen-up). Thus, the display mode of the trajectory of handwriting can be changed by voice immediately after pen-up.

For example, when the audio inputter 121 accepts an input including an audio command “undo” immediately after pen-up, the controller 180 recognizes the audio command and may delete the trajectory of handwriting such as a character and a graphic input during the touched state.

Alternatively, when the audio inputter 121 accepts an input including an audio command “eraser” immediately after pen-up, the controller 180 recognizes the audio command and may enter a mode to delete the trajectory of handwriting such as a character and a graphic input during the touched state, display a pointer (or an eraser icon) that is used to indicate a portion to be deleted with the electronic pen 200, and then delete the portion indicated with the electronic pen 200.

Alternatively, when the audio inputter 121 accepts an input including an audio command “switch to the red pen” immediately after pen-up, the controller 180 recognizes the audio command and changes the color of the trajectory of handwriting such as a character and a graphic input during the touched state to red.

Alternatively, when the audio inputter 121 accepts an input including an audio command “change the line width to the thickest width” immediately after pen-up, the controller 180 recognizes the audio command and changes the line width of the trajectory of handwriting such as a character and a graphic input during the touched state to the thickest width.

The handwriting input state may include an untouched state immediately before the touched state. In particular, the handwriting input state includes an untouched state in a predetermined time period before the time t2 of contact of the electronic pen 200 with the display surface (i.e., the time of pen-down). Thus, the display mode of the trajectory of handwriting can be changed by voice immediately before pen-up.

For example, when the audio inputter 121 accepts an input including an audio command “switch to the red pen” immediately before pen-down, the controller 180 recognizes the audio command and sets the pen color to red so that the color of the trajectory of handwriting such as a character and a graphic input during the touched state will be red.

Alternatively, when the audio inputter 121 accepts an input including an audio command “change the line width to the thickest width” immediately before pen-up, the controller 180 recognizes the audio command and sets the line width to the thickest width so that the line width of the trajectory of handwriting such as a character and a graphic input during the touched state will be the thickest width.

### (Example of Operational Flow)

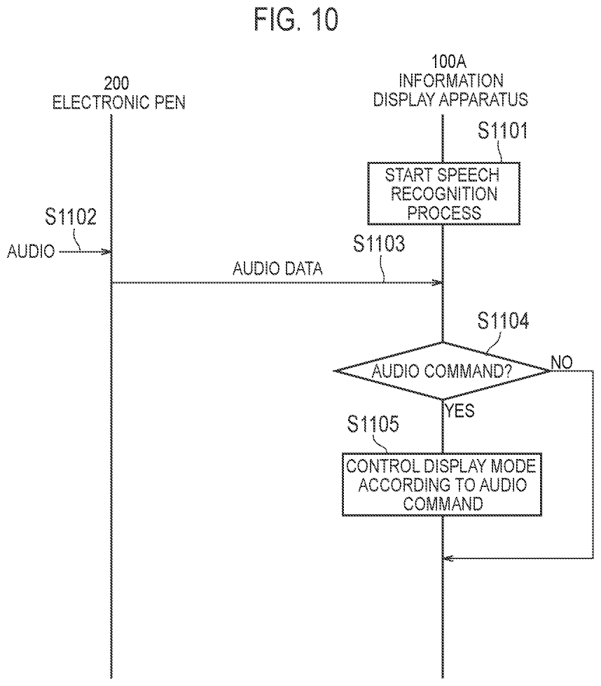

FIG. 10 is a diagram illustrating an exemplary operational flow of the information display apparatus 100A and the electronic pen 200. A radio connection (e.g., a connection for short-range radio communication) is established between the information display apparatus 100A and the electronic pen 200.

As illustrated in FIG. 10, in step S1101, the controller 180 of the information display apparatus 100A starts a speech recognition process. After the start of the speech recognition process, the controller 180 can recognize predetermined audio commands in the handwriting input state.

The controller 180 of the information display apparatus 100A may start the speech recognition process in response to launch of the handwriting input application. This enables the controller 180 to start the speech recognition process in a timely manner.

Alternatively, the controller 180 of the information display apparatus 100A may start the speech recognition process in response to a press-down operation (first operation) on the operator 210 of the electronic pen 200 while the handwriting input application is running A user presses down the operator 210 of the electronic pen 200 before he/she utters a voice corresponding to an audio command. This enables the controller 180 to start the speech recognition process in a timelier manner.

The controller 180 of the information display apparatus 100A may start the speech recognition process in response to detection of pen pressure by the sensor 240 (pen pressure sensor) of the electronic pen 200 while the handwriting input application is running Alternatively, the controller 180 of the information display apparatus 100A may start the speech recognition process in response to detection of a touch input (pen-down) by the touch panel 111 while the handwriting input application is running. This enables the controller 180 to start the speech recognition process in a timely manner without the user pressing down the operator 210 of the electronic pen 200.

In step S1102, the microphone 220 of the electronic pen 200 picks up input audio. The microphone 220 of the electronic pen 200 converts the audio into audio data and outputs the audio data to the controller 270 of the electronic pen 200.

In step S1103, the controller 270 of the electronic pen 200 transmits the audio data input by the microphone 220 of the electronic pen 200 to the information display apparatus 100A via the communication interface 260 of the electronic pen 200. The audio inputter 121 of the information display apparatus 100A accepts audio input by obtaining the audio data from the electronic pen 200 and outputs the audio data to the controller 180 of the information display apparatus 100A.

In step S1104, the controller 180 of the information display apparatus 100A performs a speech recognition process on the audio data input by the audio inputter 121 to determine whether the audio data contains an audio command

If the audio data contains an audio command, in step S1105, the controller 180 of the information display apparatus 100A controls the display mode of the trajectory of handwriting on the displayer 112 according to the audio command

The controller 180 of the information display apparatus 100A terminates the speech recognition process in response to termination of the handwriting input application.

Alternatively, the controller 180 of the information display apparatus 100A may be allowed to perform speech recognition only while the operator 210 of the electronic pen 200 is pressed down. In this case, the controller 180 may terminate the speech recognition process in response to release of the operator 210 (a second operation).

Alternatively, the controller 180 of the information display apparatus 100A may be allowed to perform speech recognition only in the touched state. In this case, the controller 180 of the information display apparatus 100A may terminate the speech recognition process when no pressure is detected by the pen pressure sensor of the electronic pen 200. Alternatively, the controller 180 of the information display apparatus 100A may terminate the speech recognition process in response to detection of a pen-up by the touch panel 111.

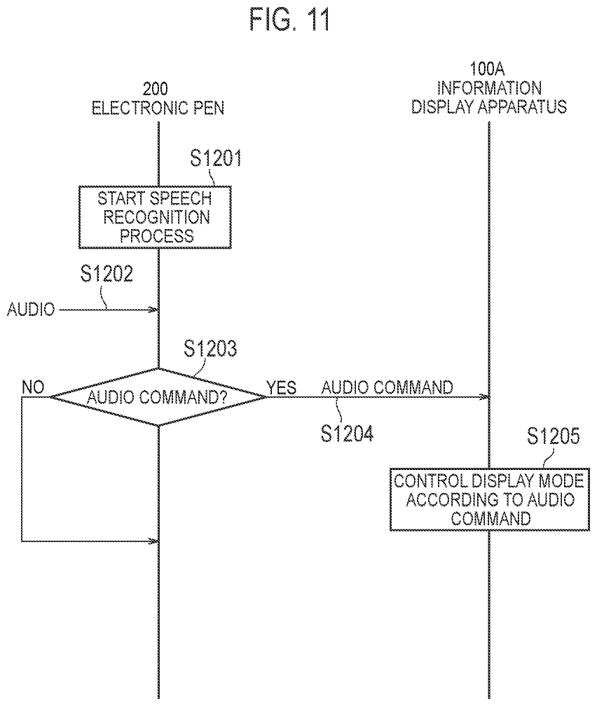

FIG. 11 is a diagram illustrating another exemplary operational flow of the information display apparatus 100A and the electronic pen 200. A radio connection (e.g., a connection for short-range radio communication) is established between the information display apparatus 100A and the electronic pen 200. The following description focuses on differences from the operation illustrated in FIG. 10.

As illustrated in FIG. 11, in step S1201, the controller 270 of the electronic pen 200 starts a speech recognition process.

The controller 270 of the electronic pen 200 may start the speech recognition process when the information display apparatus 100A notifies the controller 270 of launch of the handwriting input application. Alternatively, the controller 270 of the electronic pen 200 may start the speech recognition process in response to a press-down operation (first operation) on the operator 210 of the electronic pen 200 while the handwriting input application is running The controller 270 of the electronic pen 200 may start the speech recognition process in response to detection of pen pressure by the sensor 240 (pen pressure sensor) of the electronic pen 200 while the handwriting input application is running.

In step S1202, the microphone 220 of the electronic pen 200 picks up input audio. The microphone 220 of the electronic pen 200 converts the audio into audio data and outputs the audio data to the controller 270 of the electronic pen 200.

In step S1203, the controller 270 of the electronic pen 200 performs a speech recognition process on the audio data input by the audio inputter 121 to determine whether the audio data contains an audio command.

If the audio data contains an audio command, in step S1204, the controller 270 of the electronic pen 200 transmits data corresponding to the audio command to the information display apparatus 100A via the communication interface 260 of the electronic pen 200. The audio inputter 121 of the information display apparatus 100A accepts audio input by obtaining the data corresponding to the audio command from the electronic pen 200 and outputs the data corresponding to the audio command to the controller 180 of the information display apparatus 100A.

In step S1205, the controller 180 of the information display apparatus 100A controls the display mode of the trajectory of handwriting on the displayer 112 according to the data corresponding to the audio command input by the audio inputter 121.

The controller 270 of the electronic pen 200 may terminate the speech recognition process when the information display apparatus 100A notifies the controller 270 of termination of the handwriting input application.

Alternatively, the controller 270 of the electronic pen 200 may be allowed to perform speech recognition only while the operator 210 of the electronic pen 200 is pressed down. In this case, the controller 270 of the electronic pen 200 may terminate the speech recognition process in response to release of the operator 210 of the electronic pen 200 (a second operation).

Alternatively, the controller 270 of the electronic pen 200 may be allowed to perform speech recognition only in the touched state. In this case, the controller 270 of the electronic pen 200 may terminate the speech recognition process when no pressure is detected by the pen pressure sensor of the electronic pen 200.

### Second Embodiment

A second embodiment will be described with a center focus on differences from the first embodiment.

When a user launches a pen input application, the user selects or taps the icon of the pen input application among a plurality of icons on the display screen after unlocking of the screen of an information display apparatus in a screen lock state by identity authentication, for example.

Since those operations to launch the pen input application are cumbersome, it is difficult to launch the pen input application swiftly.

In view of the above, the second embodiment enables a pen input application to be launched swiftly.

The configuration of an information display apparatus 100A according to the second embodiment will be described with reference to FIG. 1 and FIG. 2.

The information display apparatus 100A identifies what type of gesture was performed based on the position of contact, the time of contact and the change of the position of contact over time detected by a touchscreen display 110. The gesture is an operation performed on the touchscreen display 110. Types of gestures that can be identified by the information display apparatus 100A includes a touch, release and tap.

A touch is a gesture of touching the touchscreen display 110 with a finger. The information display apparatus 100A identifies a gesture of touching the touchscreen display 110 as a contact.

A release is a gesture of removing a finger from the touchscreen display 110. The information display apparatus 100A identifies a gesture of removing a finger from the touchscreen display 110 as a release.

A tap is a gesture of performing a touch followed by a release. The information display apparatus 100A identifies a gesture of performing a touch followed by a release as a tap.

The touch panel 111 inputs a signal corresponding to a detected contact operation with the indication body to the controller 180. The touch panel 111 accepts handwriting input with an electronic pen during execution of a pen input application that is described below.

The displayer 112 displays objects such as characters, images and graphics on a screen based on a signal input by the controller 180. The displayer 112 also displays the trajectory of handwriting (e.g., a character or a graphic) input to and accepted by the touch panel 111 during execution of the pen input application.

A sensor 150 further includes a vibration sensor. The vibration sensor detects a vibration conducted to the information display apparatus 100A.

Programs stored in the storage 160 includes the pen input application. The pen input application is an application that accepts handwriting input with an electronic pen by the touch panel 111 and displays the trajectory of the handwriting (e.g., a character or a graphic) by the displayer 112.

### (Operation of Pen Input System)

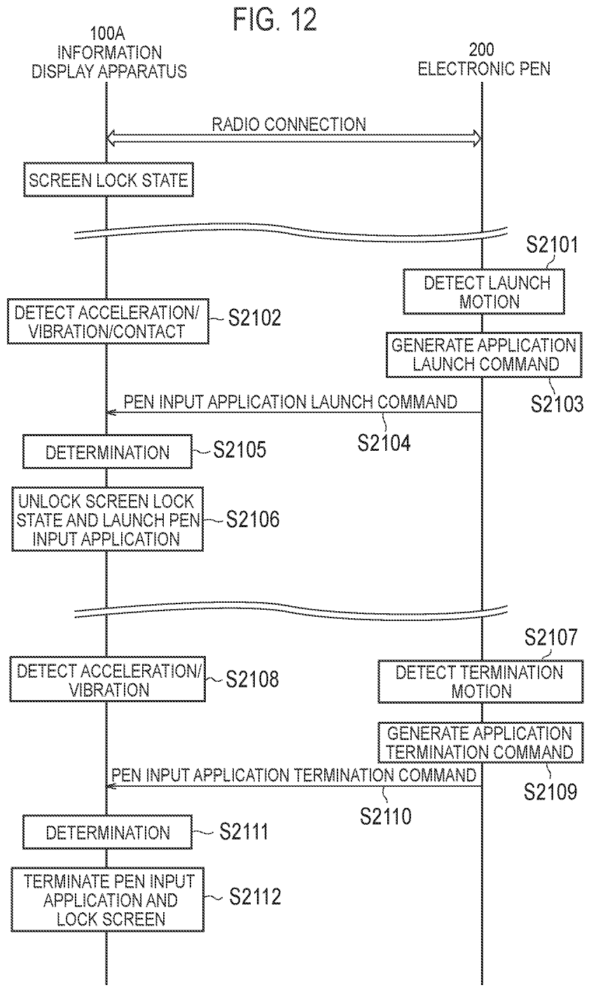

In the second embodiment, the information display apparatus 100A and an electronic pen 200 constitute a pen input system. FIG. 12 is a diagram illustrating an operational flow of a pen input system according to the second embodiment. Operation to launch the pen input application is described first.

As illustrated in FIG. 12, a radio connection (e.g., a radio connection for short-range radio communication) is established between the information display apparatus 100A and the electronic pen 200.

The controller 180 of the information display apparatus 100A controls the sensor 150 to detect acceleration or vibration when a radio connection to the electronic pen 200 is established. The controller 180 of the information display apparatus 100A may control the touch panel 111 to detect contact with an indication body when a radio connection to the electronic pen 200 is established.

A controller 270 of the electronic pen 200 controls a sensor 240 to detect acceleration or pen pressure when a radio connection to the information display apparatus 100A is established.

The information display apparatus 100A is in a screen lock state. The screen lock state is a state in which the screen (displayer 112) of the information display apparatus 100A is turned off. Unlocking the screen lock state may require identity authentication including password input.

In step S2101, the controller 270 of the electronic pen 200 detects a launch motion to launch the pen input application based on a detection signal from the sensor 240.

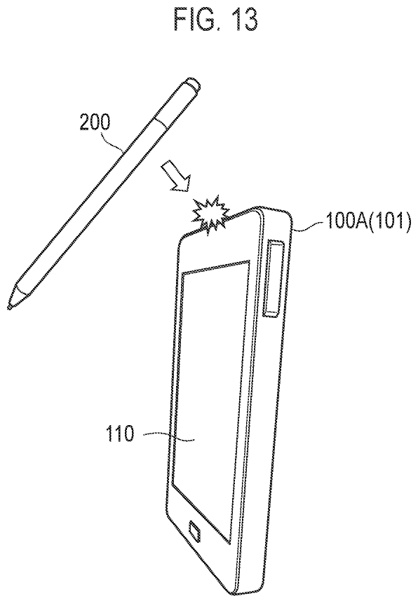

The launch motion may be a motion of contacting the upper portion of the information display apparatus 100A with the upper portion of the electronic pen 200 as illustrated in FIG. 13.

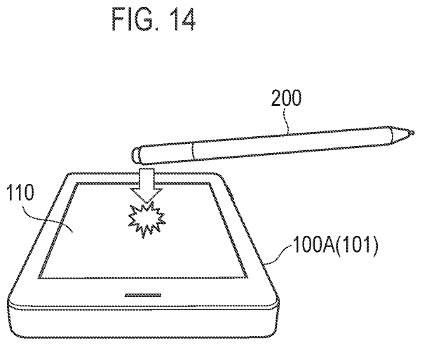

The launch motion may be a motion of contacting the touchscreen display 110 of the information display apparatus 100A with the upper portion of the electronic pen 200 as illustrated in FIG. 14.

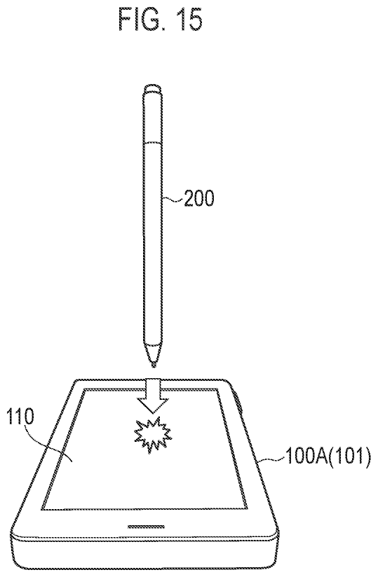

The launch motion may be a motion of contacting the information display apparatus 100A with a core body 203 of the electronic pen 200 as illustrated in FIG. 15.

The launch motion is not limited to a motion of contacting the information display apparatus 100A with the electronic pen 200 once, and may be a motion of contacting the information display apparatus 100A with the electronic pen 200 predetermined times (e.g., twice) in succession.

The controller 270 can detect the launch motion by detecting acceleration in a horizontal direction and/or in a vertical direction by the sensor 240 (acceleration sensor) in the electronic pen 200. Alternatively, the controller 270 may detect the launch motion by detecting pen pressure by the sensor 240 (pen pressure sensor).

In the launch motion, contacting the information display apparatus 100A with the electronic pen 200 generates a vibration (shock) in the information display apparatus 100A, which results in certain constant acceleration.

In step S2102, the controller 180 of the information display apparatus 100A detects acceleration or vibration being exerted on the information display apparatus 100A based on a detection signal from the sensor 150 (acceleration sensor or vibration sensor). Alternatively, the controller 180 of the information display apparatus 100A may detect contact of the electronic pen 200 with the touch panel 111 based on a detection signal from the touch panel 111.

In step S2103, the controller 270 of the electronic pen 200 generates a pen input application launch command to launch the pen input application in response to detection of a launch motion in step S101. In the second embodiment, the controller 270 of the electronic pen 200 functions as a launch command generator that generates the pen input application launch command

In step S2104, the controller 270 of the electronic pen 200 transmits the pen input application launch command generated in step S2103 to the information display apparatus 100A via a communication interface 260. In the second embodiment, the communication interface 260 and the controller 270 of the electronic pen 200 function as a transmitter that transmits the pen input application launch command.

The controller 180 of the information display apparatus 100A receives the pen input application launch command via a communication interface 170. In the second embodiment, the communication interface 170 and the controller 180 of the information display apparatus 100A function as a receiver that receives the pen input application launch command

In step S2105, the controller 180 of the information display apparatus 100A determines whether the information display apparatus 100A was contacted with the electronic pen 200 in response to reception of the pen input application launch command in step S2104. In this flow, the controller 180 of the information display apparatus 100A determines that the information display apparatus 100A was contacted with the electronic pen 200 because acceleration, vibration or contact corresponding to a launch motion is detected in step S2102. That is, the controller 180 of the information display apparatus 100A can determine that the information display apparatus 100A was contacted with the electronic pen 200 based on the acceleration or vibration detected based on a detection signal from the sensor 150 as well as the pen input application launch command

If acceleration, vibration or contact corresponding to a launch motion is not detected in a certain period of time before reception of the pen input application launch command, the controller 180 of the information display apparatus 100A determines that the pen input application launch command received from the electronic pen 200 is invalid and therefore discards or ignores the pen input application launch command

If the controller 180 of the information display apparatus 100A determines that the information display apparatus 100A was contacted with the electronic pen 200, in step S2106, the controller 180 unlocks the screen lock state and launches the pen input application. That is, the controller 180 of the information display apparatus 100A can launch the pen input application based on the acceleration or vibration detected based on a detection signal from the sensor 150 as well as the pen input application launch command

The controller 180 of the information display apparatus 100A controls the touch panel 111 to accept handwriting input with the electronic pen 200 by executing the pen input application. The controller 180 of the information display apparatus 100A also controls the displayer 112 to display the trajectory of handwriting (e.g., a character or a graphic) input to and accepted by the touch panel 111 by executing the pen input application.

Operation to terminate the pen input application is now be described.

In step S2107, the controller 270 of the electronic pen 200 detects a termination motion to terminate the pen input application based on a detection signal from the sensor 240.

During execution of the pen input application, the motions illustrated in FIG. 14 and FIG. 15 could be mistakenly recognized as handwriting input operations. Thus, the termination motion may be a motion of contacting the upper portion of the information display apparatus 100A with the upper portion of the electronic pen 200 as illustrated in FIG. 13. The termination motion is not, however, limited to a motion of contacting the upper portion of the information display apparatus 100A with the electronic pen 200, and may be a motion of contacting any portion of the information display apparatus 100A except the touchscreen display 110 with the electronic pen 200. In addition, the termination motion is not limited to a motion of contacting the information display apparatus 100A with the electronic pen 200 once, and may be a motion of contacting the information display apparatus 100A with the electronic pen 200 predetermined times (e.g., twice) in succession.

The controller 270 can detect the termination motion by detecting acceleration in a horizontal direction and/or in a vertical direction by the sensor 240 (acceleration sensor) in the electronic pen 200.

In the termination motion, contacting the information display apparatus 100A with the electronic pen 200 generates a vibration (shock) in the information display apparatus 100A, which results in certain constant acceleration.

In step S2108, the controller 180 of the information display apparatus 100A detects acceleration or vibration being exerted on the information display apparatus 100A based on a detection signal from the sensor 150 (acceleration sensor or vibration sensor).

In step S2109, the controller 270 of the electronic pen 200 generates a pen input application termination command to terminate the pen input application in response to detection of a termination motion in step S2107. In the second embodiment, the controller 270 of the electronic pen 200 functions as a termination command generator that generates the pen input application termination command

In step S2110, the controller 270 of the electronic pen 200 transmits the pen input application termination command generated in step S2109 to the information display apparatus 100A via the communication interface 260. The controller 180 of the information display apparatus 100A receives the pen input application termination command via the communication interface 170.

In step S2111, the controller 180 of the information display apparatus 100A determines whether the information display apparatus 100A was contacted with the electronic pen 200 in response to reception of the pen input application termination command in step S2110. In this flow, the controller 180 of the information display apparatus 100A determines that the information display apparatus 100A was contacted with the electronic pen 200 because acceleration or vibration corresponding to a termination motion is detected in step S2108. That is, the controller 100 of the information display apparatus can determine that the information display apparatus 100A was contacted with the electronic pen 200 based on the acceleration or vibration detected based on a detection signal from the sensor 150 as well as the pen input application termination command

If acceleration or vibration corresponding to a termination motion is not detected in a certain period of time before reception of the pen input application termination command, the controller 180 of the information display apparatus 100A determines that the pen input application termination command received from the electronic pen 200 is invalid and therefore discards or ignores the pen input application termination command.

If the controller 180 of the information display apparatus 100A determines that the information display apparatus 100A was contacted with the electronic pen 200, in step S2112, the controller 180 terminates the pen input application. That is, the controller 180 of the information display apparatus 100A can terminate the pen input application based on the acceleration or vibration detected based on a detection signal from the sensor 150 as well as the pen input application termination command The controller 180 of the information display apparatus 100A may automatically store the trajectory of handwriting (a character or a graphic) input during execution of the pen input application in the storage 160. The controller 180 of the information display apparatus 100A may lock the screen when the pen input application is terminated.

As described above, in the pen input system according to the second embodiment, the electronic pen 200 includes the sensor 240 to detect acceleration or pen pressure and means for transmitting data depending on the result of detection by the sensor 240 to the information display apparatus 100A. The information display apparatus 100A includes means for receiving data depending on the result of detection by the sensor 240 from the electronic pen 200 and the controller 180 that launch the pen input application based on the received data.

Accordingly, the pen input application is launched by the information display apparatus 100A based on acceleration exerted on the electronic pen 200 or pen pressure, and therefore a user does not need to select and tap the icon of the pen input application among a plurality of icons. In addition, the pen input application can be launched by a motion of the electronic pen 200, and thus the pen input application can be launched swiftly.

In the second embodiment, the controller 180 of the information display apparatus 100A unlocks the screen lock state and launches the pen input application. This eliminates the need for performing input operations (including identity authentication) to unlock the screen lock state, thereby enabling the pen input application to be launched swiftly.

In the second embodiment, the electronic pen 200 generates a launch command to launch the pen input application based on the result of detection by the sensor 240 and transmits the generated launch command to the information display apparatus 100A. Consequently, the pen input application can be launched efficiently as compared to the case of providing the result of detection by the sensor 240 from the electronic pen 200 to the information display apparatus 100A.

It is noted that if the processing power of the electronic pen 200 is low, the result (detection data) of detection by sensor 240 may be provided from the electronic pen 200 to the information display apparatus 100A and the motion detection in steps S2101 and S2107 may be performed in the information display apparatus 100A.

In the second embodiment, the information display apparatus 100A includes the sensor 150 to detect acceleration or vibration exerted on the information display apparatus 100A. If it is determined that the information display apparatus 100A was contacted with the electronic pen 200 based on the result of detection by the sensor 150, the controller 180 of the information display apparatus 100A launches the pen input application. Alternatively, if it is determined that the information display apparatus 100A was contacted with the electronic pen 200 based on the result of detection by the touch panel 111, the controller 180 of the information display apparatus 100A may launch the pen input application.

In the second embodiment, after the pen input application is launched, if it is determined that any portion of the information display apparatus 100A except the touchscreen display 110 (touch panel 111), for example, an edge portion of the housing 101 of the information display apparatus 100A, was contacted with the electronic pen 200 based on the result of detection by the sensor 150, the controller 180 of the information display apparatus 100A terminates the pen input application.

If the pen input application is launched or terminated based only on motion detection in the electronic pen 200, unwanted operation, more specifically, launch or termination of the pen input application which is not intended by a user may occur. By launching or terminating the pen input application on condition that a user brings the electronic pen 200 into contact with the information display apparatus 100A, such unwanted operation can be suppressed.

### Variations of Second Embodiment

In the second embodiment, the sensor 150 of the information display apparatus 100A may further includes an illuminance sensor. The illuminance sensor includes a photodetector and detects the amount of incident light. The controller 180 of the information display apparatus 100A may determine not only whether the information display apparatus 100A was contacted with the electronic pen 200 (step S2105 in FIG. 12) but also whether the illuminance sensor is detecting a certain level of illuminance.

The controller 180 of the information display apparatus 100A may launch the pen input application when it is determined that the information display apparatus 100A was contacted with the electronic pen 200 and the illuminance sensor is detecting a certain level of illuminance. This can prevent the pen input application from being mistakenly launched when the information display apparatus 100A is in a bag or a pocket.

In the second embodiment, the controller 180 of the information display apparatus 100A may determine not only whether the information display apparatus 100A was contacted with the electronic pen 200 (step S2105 in FIG. 12) but also whether a user is looking at the displayer 112 (touchscreen display 110) based on the result of face recognition using an image captured by a camera 140.

The controller 180 of the information display apparatus 100A may launch the pen input application if it is determined that the information display apparatus 100A was contacted with the electronic pen 200 and the user is looking at the displayer 112 (touchscreen display 110). This can further suppress unwanted operation.

In the second embodiment, an example is described in which the pen input application is launched by a launch motion in the screen lock state. The pen input application may, however, be launched by a launch motion in a state immediately after the screen lock state is unlocked (i.e., in the home screen).

### Third Embodiment

A third embodiment will be described with a center focus on differences from the first embodiment and the second embodiment.

When a first user and a second user have an interlingual conversation via an electronic device, a typical process is as follows.

First, the first user raises the electronic device to his/her mouth and speaks to the electronic device and then passes the electronic device to the second user to show the result of translation by the electronic device to the second user.

Next, the second user raises the electronic device to his/her mouth and speaks to the electronic device and then passes the electronic device to the first user to show the result of translation by the electronic device to the first user.

Although an interlingual conversation is possible by repeating this process, since it takes time to pass the electronic device to each other, the conversation cannot be conducted smoothly.

In view of the above, the object of a third embodiment is to achieve a smooth interlingual conversation.

### (Configuration of Electronic Device)

The configuration of an electronic device 100B according to the third embodiment will be described.

The electronic device according to the third embodiment may be a terminal such as a smartphone and a tablet. The electronic device is, however, not limited to such a terminal and may be a personal computer, a wearable device or an onboard electronic device.

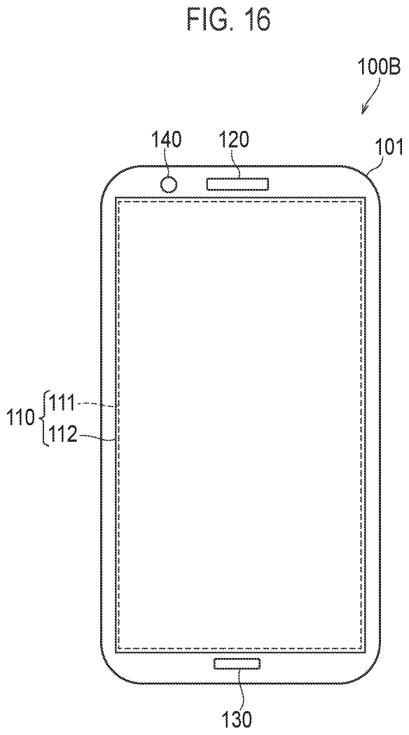

FIG. 16 is a diagram illustrating the exterior of the electronic device 100B according to the third embodiment.

As illustrated in FIG. 16, the electronic device 100B includes a touchscreen display 110, a microphone 120, a speaker 130 and a camera 140.

The touchscreen display 110 is provided with its display surface exposed outside the housing 101 of the electronic device 100B. The touchscreen display 110 includes a touch panel 111 and a displayer (display) 112.

The touch panel 111 accepts operational input to the electronic device 100B. The touch panel 111 detects a contact with an indication body such as user's finger or an input pen. For example, resistive contact detection or capacitive contact detection may be executed for detecting a contact but any other kind of contact detection may also be used.

The displayer 112 generates visual output. The displayer 112 display objects such as characters (including symbols), images and graphics on the screen. For example, a liquid crystal display or an organic electro luminescence (EL) display may be used for the displayer 112.

In the touchscreen display 110 according to the third embodiment, the displayer 112 is provided so that the displayer 112 can overlap the touch panel 111 and thus the display area of the displayer 112 can also overlap the touch panel 111. The displayer 112 and the touch panel 111 may, however, be placed side by side or even spaced instead of providing the displayer 112 and the touch panel 111 so that they can overlap.

The electronic device 100B identifies what type of gesture was performed based on the position of contact, the time of contact and the change of the position of contact over time detected by a touchscreen display 110. The gesture is an operation performed on the touchscreen display 110. Types of gestures that can be identified by the electronic device 100B includes a touch, release and tap.

A touch is a gesture of touching the touchscreen display 110 with a finger. The electronic device 100B identifies a gesture of touching the touchscreen display 110 as a contact.

A release is a gesture of removing a finger from the touchscreen display 110. The electronic device 100B identifies a gesture of removing a finger from the touchscreen display 110 as a release.

A tap is a gesture of performing a touch followed by a release. The electronic device 100B identifies a gesture of performing a touch followed by a release as a tap.

The microphone 120 accepts audio input to the electronic device 100B. The microphone 120 picks up surrounding sounds.

The speaker 130 generates audio output. The speaker 130 outputs audio on the telephone or information for a variety of programs as audio output.

The camera 140 captures images electronically using an image sensor such as a charge coupled device (CCDs) or a complementary metal oxide semiconductor (CMOS). The camera 140 is a front camera that captures images of objects located in front of the touchscreen display 110. The electronic device 100B may further includes a rear camera to capture images of objects located on the back side of the touchscreen display 110.

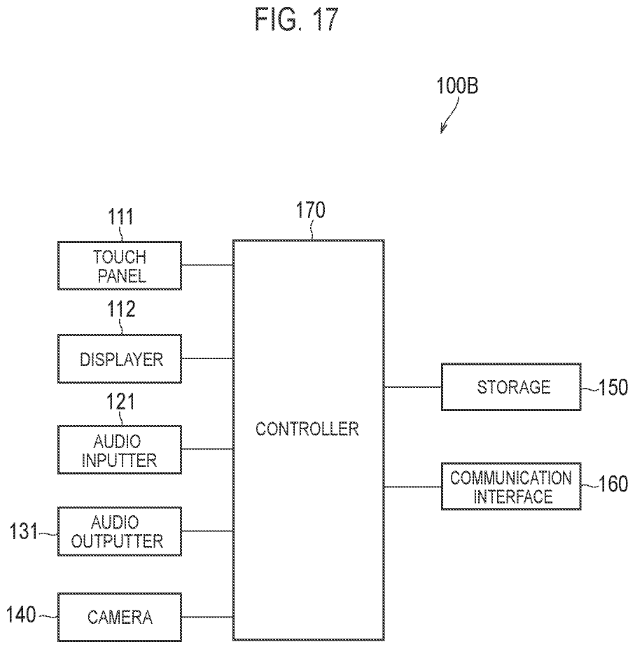

FIG. 17 is a block diagram illustrating the functional configuration of the electronic device according to the third embodiment.

As illustrated in FIG. 17, the electronic device 100B includes the touch panel 111, the displayer 112, an audio inputter 121, an audio outputter 131, the camera 140, a storage 150, a communication interface 160 and the controller 170.

The touch panel 111 inputs a signal corresponding to a detected contact operation with the indication body to the controller 170.

The displayer 112 displays objects such as characters, images and graphics on the screen based on a signal input by the controller 170.

The audio inputter 121 inputs a signal corresponding to an accepted audio input to the controller 170. The audio inputter 121 includes the aforementioned microphone 120. The audio inputter 121 may be an input interface to which an external microphone can be connected. The external microphone is connected in a wired or wireless manner. The microphone connected to the input interface may be a microphone integrated with earphones that can be connected to the electronic device 100B, for example.

The audio outputter 131 outputs audio based on a signal input by the controller 170. The audio outputter 131 includes the aforementioned speaker 130. The audio outputter 131 may be an output interface to which an external speaker can be connected. The external speaker is connected in a wired or wireless manner. The speaker connected to the output interface may be a speaker included in earphones that can be connected to the electronic device, for example.

The camera 140 converts a captured image into an electronic signal and inputs the electronic signal to the controller 170.

The storage 150 stores programs and data. The storage 150 is also used as a workspace for temporarily storing results of processing by the controller 170. The storage 160 may include any non-transitory storage medium such as a semiconductor storage medium and a magnetic storage medium.

The storage 150 may include multiple types of storage media. The storage 150 may include a combination of a portable storage medium such as a memory card, an optical disc and a magneto-optical disc and a reader for the storage medium. The storage 150 may include a memory device, for example, a random access memory (RAM), which can be used as a temporary storage area.

Programs stored in the storage 150 includes applications that can be executed in the foreground or background and a control program that supports operations of those applications.

Programs stored in the storage 150 includes a speech translation application. The speech translation application is an application that performs a speech recognition process and a translation process to another language and presents the result of translation. The storage 150 also stores a database for the speech translation application to perform the speech recognition process and the translation process. The speech translation application may perform the speech recognition process and the translation process in cooperation with an external server.

The communication interface 160 can communicate wirelessly. The communication interface 160 may support radio communication standards including cellular communication standards such as 2G, 3G and 4G and short-range radio communication standards. Examples of the short-range radio communication standards include IEEE 802.11, Bluetooth (R), Infrared Data Association (IrDA), Near Field Communication (NFC) and Wireless Personal Area Network (WPAN). ZigBee (R) is an example of the WPAN communication standard.

The controller 170 is an arithmetic processing device. The arithmetic processing device includes for example, but is not limited to, a central processing unit (CPU), a system-on-chip (SoC), a micro control unit (MCU), a field-programmable gate array (FPGA) and a coprocessor. The controller 170 realizes a wide variety of functions by orchestrating the operation of the electronic device 100B.

The controller 170 detects whether the electronic device 100B is connected with an external device. The connections may be established in a wired or wireless manner. An example of communication standards for radio connection is Bluetooth (R). The controller 170 communicates with the external device via the communication interface 160. The connected external device may be the aforementioned earphones, a headset, an onboard speaker with a microphone or an input pen (electronic pen) with a microphone and a speaker. It is noted that the communication standards for radio connection and the external device are not limited to those described above. It is noted that the communication standards for radio connection and the external device are not limited to those described above. In the following, an electronic pen is connected as an external device by way of example.

The controller 170 performs various kinds of control based on a signal input depending on a contact operation detected by the touch panel 111. For example, the controller 170 controls the audio outputter 131 or the displayer 112 to generate output according to an input signal. The controller 170 also executes functions and changes settings of the electronic device 100B.

The controller 170 performs a first process and a second process by the speech translation application if the electronic device 100B is connected with the external device.

The first process is a process of converting (translating) audio data in a first language obtained by the audio inputter 121 to audio data in a second language and transmitting the audio data in the second language to the external device via the communication interface 160. The first process may include a process of outputting audio corresponding to the audio data in the second language by the external device.

The second process is a process of receiving audio data in the second language obtained by the external device from the electronic pen 200 via the communication interface 160, converting (translating) the audio data in the second language to audio data in the first language, and outputting audio corresponding to the audio data in the first language by the audio outputter 131.

The first language and the second language may be any languages as long as they are different languages, for example, the first language is Japanese and the second language is English. The controller 170 may set the first language and the second language according to an operational input accepted by the touch panel 111. For example, the controller 170 directs the displayer 112 to display options of the first language and the second language and sets the first language and the second language to the selected languages when the touch panel 111 accepts an operational input to select the first language and the second language from those options.

Alternatively, the controller 170 may automatically set the first language to a language registered as the default language with the control program (operating system). In this case, the controller 170 may set the second language according to an operational input.

### (Configuration of Electronic Pen)

The electronic pen 200 according to the third embodiment is an input pen that can be used for input operation on the touch panel 111 of the electronic device 100B.

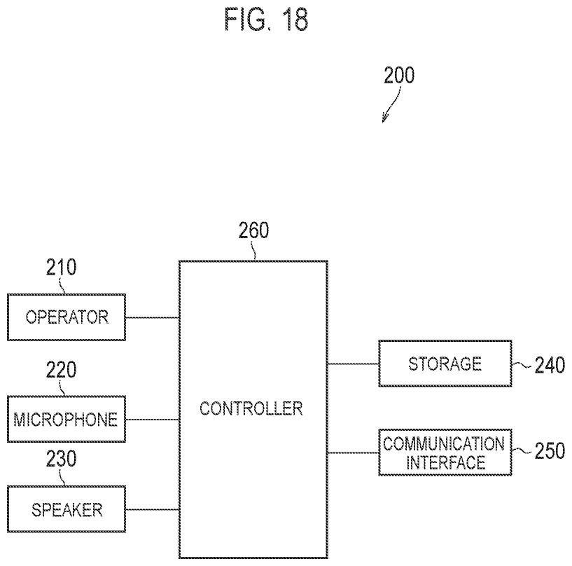

FIG. 18 is a block diagram illustrating the functional configuration of the electronic pen 200 according to the third embodiment.

As illustrated in FIG. 18, the electronic pen 200 includes the operator 210, a microphone 220, a speaker 230 , a storage 240, a communication interface 250 and a controller 260.

The operator 210 inputs a signal corresponding to a detected press-down operation to the controller 260.

The microphone 220 picks up surrounding sounds. The microphone 220 accepts an audio input to the electronic pen 200 and inputs a signal corresponding to the accepted audio input to the controller 260.

The speaker 230 generates audio output. The speaker 230 outputs audio on the telephone or information for a variety of programs as audio output. The speaker 230 outputs audio based on a signal input by the controller 260.

The storage 240 stores programs and data. The storage 240 is also used as a workspace for temporarily storing results of processing by the controller 260. The storage 240 may include any non-transitory storage medium such as a semiconductor storage medium and a magnetic storage medium.

The storage 240 may include multiple types of storage media. The storage 240 may include a combination of a portable storage medium such as a memory card and a reader for the storage medium. The storage 240 may include a memory device, a RAM, which can be used as a temporary storage area.

The communication interface 250 can communicate wirelessly. The communication interface 250 may support radio communication standards including the aforementioned cellular communication standards and short-range radio communication standards.

The controller 260 is an arithmetic processing device. The arithmetic processing device includes, but is not limited to, a CPU, an SoC, an MCU, an FPGA and a coprocessor. The controller 260 realizes a wide variety of functions by orchestrating the operation of the electronic pen 200.

The controller 260 detects whether the electronic pen 200 is connected with the electronic device 100B. The connection may be established in a wired or wireless manner. An example of communication standards for radio connection is Bluetooth (R). The controller 260 communicates with the electronic device 100B via the communication interface 250.

The controller 260 performs various kinds of control based on a signal input depending on a press-down operation detected by the operator 210. The controller 260 transmits/receives audio data to/from the electronic device 100B via the communication interface 250 if the electronic pen 200 is connected with the electronic device 100B.

The controller 260 receives audio data in the second language from the electronic device 100B via the communication interface 250 and directs the speaker 230 to output the received audio data. The controller also transmits audio data in the second language obtained by the microphone 220 to the electronic device 100B via the communication interface 250.

### (Operation of Electronic Device and Electronic Pen)

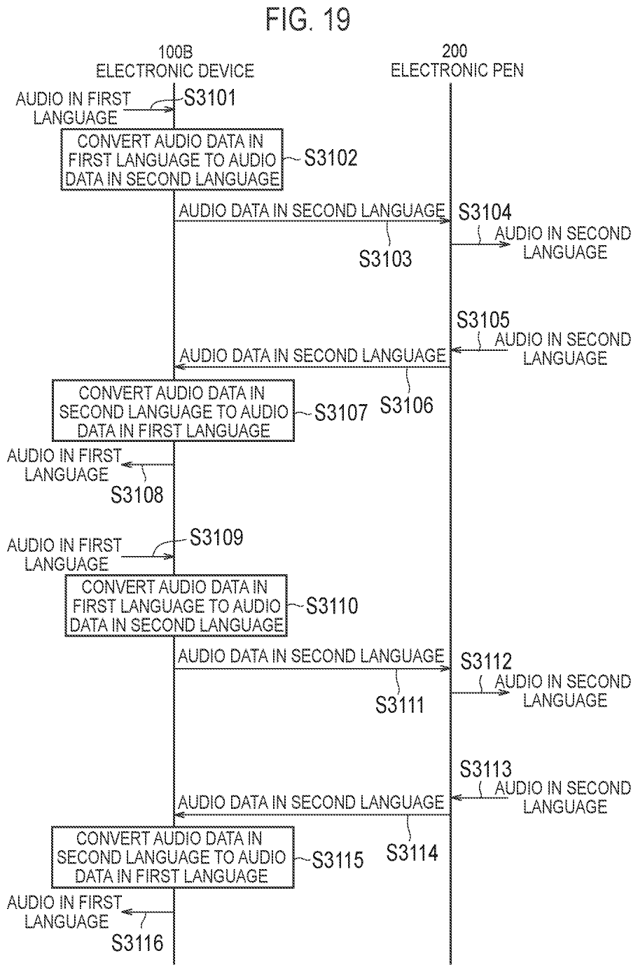

FIG. 19 is a diagram illustrating an operational flow of the electronic device 100B and the electronic pen 200 according to the third embodiment. This operational flow starts when a radio connection (e.g., a radio connection for short-range radio communication) is established between the electronic device 100B and the electronic pen 200 and the electronic device 100B launches the speech translation application. In this operational flow, the electronic device 100B serves as a master that controls the electronic pen 200 that serves as a slave.

In this operational flow, the electronic device 100B is held by a first user and the electronic device 100B is held by a second user.

As illustrated in FIG. 19, in step S3101, the audio inputter 121 of the electronic device 100B accepts audio in the first language input by the first user and outputs a signal (audio data) corresponding to the audio input to and accepted by the audio inputter 121 to the controller 170.

In step S3102, the controller 170 of the electronic device 100B converts the audio data in the first language input by the audio inputter 121 to audio data in the second language.

In step S3103, the controller 170 of the electronic device 100B transmits the audio data in the second language obtained by converting the audio data in the first language to the electronic pen 200 via the communication interface 160. The controller 170 of the electronic device 100B does not allow the audio outputter 131 to output the audio data in the second language obtained by converting the audio data in the first language.

The controller 260 of the electronic pen 200 receives the audio data in the second language from the electronic device 100B via the communication interface 250.

In the step S3104, the controller 260 of the electronic pen 200 outputs the audio data in the second language received from the electronic device 100B to the speaker 230 and directs the speaker 230 to output audio corresponding to the audio data.

In the step S3105, the microphone 220 of the electronic pen 200 accepts audio in the second language input by the second user and outputs a signal (audio data) corresponding to the audio input to and accepted by the microphone 220 to the controller 260.

In the step S3106, the controller 260 of the electronic pen 200 transmits the audio data in the second language input by the microphone 220 to the electronic device 100B via the communication interface 250.

The controller 170 of the electronic device 100B receives the audio data in the second language from the electronic pen 200 via the communication interface 160.

In step S3107, the controller 170 of the electronic device 100B converts the audio data in the second language received from the electronic pen 200 to audio data in the first language.

In step S3108, the controller 170 of the electronic device 100B outputs the audio data in the first language obtained by converting the audio data in the second language to the audio outputter 131 and directs the audio outputter 131 to output audio corresponding to the audio data. The controller 170 of the electronic device 100B does not transmit the audio data in the first language obtained by converting the audio data in the second language to electronic pen 200.

After that, in steps S3109 to S3116, the same procedure as that in steps S3101 to S3108 is repeated so that the first user and the second user can have an interlingual conversation via the electronic device 100B and the electronic pen 200. Although this operational flow assumes that the first user speaks first, in another scenario in which the second user is the first speaker, the flow starts in step S5.

Unlike conventional operation, in this operation of the electronic device 100B and the electronic pen 200, when the first user and the second user have an interlingual conversation via the electronic device 100B, due to the electronic pen 200 kept in the vicinity of the second user, the electronic device 100B does not need to be passed between the first user and the second user frequently. Thus, time consumed in passing the electronic device 100B between the first user and the second user is eliminated, and therefore the conversation can be conducted smoothly.

Since the electronic pen 200 can be used for input operation on the touch panel 111 of the electronic device 100B, it is expected that the first user carries the electronic pen 200 with the electronic device 100B. Using the electronic pen 200 for the aforementioned operation can enhance convenience for users.

### Other Embodiments

In the aforementioned embodiments, a case is not described in which the electronic pen 200 can be held in the information display apparatus 100A or the electronic device 100B but a holder for the electronic pen 200 may be provided in the information display apparatus 100A and the electronic device 100B to hold the electronic pen 200 in the information display apparatus 100A and the electronic device 100B.

A program may be provided to cause a computer to execute the operations of the information display apparatus 100A and the electronic device 100B. The program may be stored in a computer-readable medium. The program can be installed on a computer from a computer-readable medium having the program stored thereon. The computer-readable medium having the program stored thereon may be a non-transitory recording medium. The non-transitory recording medium may include, but is not limited to, a CD-ROM and a DVD-ROM.

While embodiments have been described in detail with reference to the drawings, specific configurations are not limited to the ones mentioned above and various design changes and the like can be made without departing from the scope of the invention.

The present application claims priory to Japanese Patent Application No. 2018-203316 (filed on Oct. 29, 2018), Japanese Patent Application No. 2018-203315 (filed on Oct. 29, 2018), Japanese Patent Application No. 2018-203313 (filed on Oct. 29, 2018), Japanese Patent Application No. 2018-203311 (filed on Oct. 29, 2018), and Japanese Patent Application No. 2018-203317 (filed on Oct. 29, 2018) the entire disclosure of which is incorporated herein by reference.

1. An information display apparatus comprising:
a touch panel configured to accept handwriting input with an indication body;
a displayer configured to display a trajectory of handwriting accepted by the touch panel;
an audio inputter configured to accept audio input including an audio command; and
a controller configured to control a display mode of the trajectory of handwriting on the displayer according to the audio command input to and accepted by the audio inputter in a handwriting input state.

2. The information display apparatus according to claim 1, wherein
the controller is further configured to change the display mode of the trajectory of handwriting on the displayer in stages according to the audio command input to and accepted by the audio inputter in the handwriting input state.

3. The information display apparatus according to claim 2, wherein
the controller is further configured to change the display mode of the trajectory of handwriting in stages when the audio command is input to and accepted by the audio inputter repeatedly in the handwriting input state.

4. The information display apparatus according to claim 1, wherein
the displayer is further configured to display a character or a graphic as the trajectory of handwriting,
the controller is further configured to change a display mode of the character or the graphic displayed by the displayer according to the audio command input to and accepted by the audio inputter in the handwriting input state, and
the display mode includes at least one of a color of the character, a size of the character, a thickness of the character, a font of the character, a decoration of the character, a color of the graphic, a size of the graphic, a line width of the graphic, and a shape of the graphic.

5. The information display apparatus according to claim 1, wherein
the indication body is an electronic pen including a microphone and capable of communicating with the information display apparatus, and
the audio inputter is configured to accept the audio input by obtaining audio data including an audio command depending on audio input to the microphone from the electronic pen.

6. The information display apparatus according to claim 1, wherein
the displayer has a display surface to display information,
the touch panel is configured to detect a touch on the display surface with the indication body, and
the handwriting input state includes a touched state in which the indication body is in touch with the display surface.

7. The information display apparatus according to claim 6, wherein
the handwriting input state further includes an untouched state in a predetermined time period after the indication body is removed from the display surface.

8. The information display apparatus according to claim 6, wherein
the handwriting input state further includes an untouched state in a predetermined time period before the indication body is brought into touch with the display surface.

9. The information display apparatus according to claim 1, wherein
the controller is configured to delete the trajectory of handwriting on the displayer according to the audio command input to and accepted by the audio inputter in the handwriting input state.

10. The information display apparatus according to claim 1, wherein
the controller is configured to, in the handwriting input state,
recognize the audio command included in the audio input accepted by the audio inputter, and
change the display mode of the trajectory of handwriting on the displayer in response to recognizing a predetermined audio command.

11. The information display apparatus according to claim 10, wherein
the controller is configured to start a speech recognition process to recognize the audio command included in the audio input accepted by the audio inputter in response to launch of a handwriting input application.

12. The information display apparatus according to claim 11, wherein
the controller is configured to terminate the speech recognition process in response to termination of the handwriting input application.

13. The information display apparatus according to claim 11, wherein
the indication body is an electronic pen including an operator and capable of communicating with the information display apparatus, and
the controller is configured to start the speech recognition process in response to a first operation on the operator while the handwriting input application is running.

14. The information display apparatus according to claim 13, wherein
the controller is configured to terminate the speech recognition process in response to a second operation on the operator.

15. The information display apparatus according to claim 11, wherein
the indication body is an electronic pen including a pen pressure sensor and capable of communicating with the information display apparatus, and
the controller is configured to start the speech recognition process in response to detection of pressure by the pen pressure sensor while the handwriting input application is running.

16. The information display apparatus according to claim 15, wherein
the controller is configured to terminate the speech recognition process when no pressure is detected by the pen pressure sensor.

17. An electronic pen functioning as the indication body in claim 1.

18. A display control method for use in an information display apparatus including a touch panel configured to accept handwriting input with an indication body, the method comprising:
accepting audio input including an audio command in a handwriting input state;
displaying a trajectory of handwriting accepted by the touch panel;
controlling a display mode of the trajectory of handwriting in displaying the trajectory, according to the audio command input and accepted in accepting the audio input.

19. A non-transitory computer-readable recording medium having stored therein a display control program that causes a computer installed in an information display apparatus including a touch panel configured to accept handwriting input with an indication body to execute:
accepting audio input including an audio command in a handwriting input state,
displaying a trajectory of handwriting accepted by the touch panel, and
controlling a display mode of the trajectory of handwriting in displaying the trajectory, according to the audio command input and accepted in accepting the audio input.

20. A pen input system comprising:
an electronic pen; and
an information display apparatus including a touch panel configured to accept handwriting input with the electronic pen, wherein
the electronic pen including
a first sensor configured to detect acceleration or pen pressure, and
a transmitter configured to transmit data depending on a result of detection by the first sensor to the information display apparatus, and
the information display apparatus including
a receiver configured to receive the data from the electronic pen, and
a processor configured to launch an application for providing the handwriting input with the electronic pen based on the data received by the receiver.

21.-39. (canceled)
